(19) United States
(12) Patent Application Publication
(10) Pub. No.: US 2019/0293352 A1
(43) Pub. Date: Sep. 26, 2019

(54) INDUSTRIAL KILN

(71) Applicant: NANJING SHIHENG ELECTRONICS CO.,LTD., Jiangning Nanjing, Jiangsu (CN)

(72) Inventors: Yang Wang, Jiangning Nanjing (CN); Xueting Wang, Jiangning Nanjing (CN)

(21) Appl. No.: 16/319,320

(22) PCT Filed: Jul. 17, 2017
(86) PCT No.: PCT/CN2017/093240

§ 371 Date: Jun. 14, 2019

(30) Foreign Application Priority Data
Jul. 18, 2016 (CN) 201610563365.4

(51) Int. Cl. F27B 9/30; F27B 9/24; F27D 17/00

(52) U.S. Cl. CPC F27B 9/3005; F27D 17/004; F27B 9/2407

(57) ABSTRACT

An industrial kiln, employing a tunnel kiln design. An upper portion of a central high-temperature firing region of a kiln body (1) has an arch structure, and is divided into a rising portion (4), a middle portion (5), and a descending portion (6). The rising portion (4), the middle portion (5), and the descending portion (6) are connected by means of curved surfaces with smooth transitions. A transporting mechanism (2) at a lower portion of the kiln body (1) is parallel to the upper portion. The present invention enables collection of excessive heat in a pre-heating portion and a cooling portion to transfer the same to a high-temperature firing portion, thus reducing a firing time and burning fuels of a high-temperature firing region, lowering a production cost, and protecting the environment by preventing exhaustion of a large amount of hot air.

### BACKGROUND

### Technical Field

The present invention relates to the field of kiln technologies, and specifically, to an industrial kiln employing a tunnel kiln design.

### Description of Related Art

The kiln is a device built of refractory materials for firing products, and is an essential facility in ceramic molding. Considerable kiln building styles and experience have been accumulated in the history of ceramics burning for thousands of years. From the ground open-air pile burning and pit digging building burning of the primitive society to the steamed-bun-shaped up-draft circular kiln, the half-down-draft horseshoe-shaped kiln, the Banpo dragon kiln, the duck-egg-shaped kiln, and to the modern indoor gas kiln and electric kiln, kiln technologies are subject to continuous improvement and development.

The tunnel kiln is a modern continuous firing thermal equipment widely used in roasting production of ceramic products. It is also used in the metallurgical industry such as abrasives. The tunnel kiln is usually a long linear tunnel with fixed walls and a vault respectively on two sides and an upper portion thereof. A kiln cart runs on a track laid at the bottom of the tunnel kiln. A combustion device is disposed on two central sides of the tunnel kiln, to form a fixed high-temperature firing region. High-temperature gas generated by combustion flows along the tunnel to the direction of a kiln head under the effect of a chimney or an induced draft fan at a front end of the tunnel kiln, and gradually preheats products entering the kiln. This section forms the pre-heating region of the tunnel kiln. Cold air is blown into a kiln tail of the tunnel kiln, to cool products in a next section in the tunnel kiln. The blown cold air flows through the products and is heated, and is then extracted into a dryer as a heat source for drying a green blank. This section forms a cooling region of the tunnel kiln.

The tunnel kiln is a continuous kiln, and therefore has relatively high heat utilization, and combustion air used in most tunnel kilns is natural wind or cold air is blown into the cooling region to heat the air. Although waste heat is utilized, because extracted hot air contains a large amount of exhaust gas burnt in the high-temperature region, oxygen in the combustion air is insufficient and the combustion effect is not good. Hot air exchanged by a heat exchanger is fresh hot air, and can achieve an optimum combustion supporting effect. If a metal heat exchanger is used, some of the waste heat can be recovered, but if the temperature of the cooling region reaches 800 degrees or more, the metal heat exchanger is easily damaged by high temperature.

### SUMMARY

In views of the foregoing existing technical problems, the present invention aims to provide an industrial kiln, employing a tunnel kiln design, and the main objective is to fully use excessive heat of a pre-heating region and a cooling region of a tunnel kiln to transfer the same to a high-temperature firing region, thereby reducing fuels required in the high-temperature firing region, lowering a cost, and also reducing exhaustion of hot air from the tunnel kiln to the outside, and reducing a temperature of a production shop. In this way, the use of a large-power air extractor can be reduced or even avoided, and thus consumption of electric energy is reduced.

To achieve the foregoing objective, the technical solution disclosed in the present invention is as follows:

An industrial kiln, employing a tunnel kiln design, and including a kiln body and a transporting mechanism that is configured to convey a member to be fired to pass through an internal chamber of the kiln body. The kiln body is of a structure with an arched middle portion, and includes a rising portion, a middle portion, and a descending portion. A front end of the rising portion is connected to a front horizontal portion, and a rear end of the descending portion is connected to a rear horizontal portion. The transporting mechanism passes through the internal chamber of the kiln body in a parallel manner, and therefore the transporting mechanism is also correspondingly divided into a front horizontal portion, a rising portion, a middle portion, a descending portion, and a rear horizontal portion. In the transporting mechanism, the front horizontal portion and the rising portion, the rising portion and the middle portion, the middle portion and the descending portion, and the descending portion and the rear horizontal portion are connected by means of curved surfaces with smooth transitions, respectively. The middle portion is a portion with a highest temperature in the kiln body, and a high-temperature firing region is formed in the middle portion. At least one part of the front horizontal portion and at least one part of the rising portion form a pre-heating region with a gradually increasing temperature, and at least one part of the descending portion and at least one part of the rear horizontal portion form a cooling region with a gradually decreasing temperature. The transporting mechanism conveys the member to be fired to sequentially pass through the front horizontal portion, the rising portion, the middle portion, the descending portion, and the rear horizontal portion.

In this technical solution, an upper portion of the central high-temperature firing region of the kiln body has an arch structure, and the pre-heating portion and the cooling portion are respectively disposed on two sides of the high-temperature firing region. According to a principle that heated air ascends upwards, hot air generated in the pre-heating portion and the cooling portion passes through the rising portion and the descending portion of the high-temperature firing region upwards and concentrates into the middle portion, to supplement heat in the middle portion. In this way, not only exhaustion of excessive heat from the pre-heating portion and the cooling portion to the outside can be reduced, but also fuels consumed in the high-temperature firing region can be reduced, thereby protecting the environment, and lowering a production cost.

In a further improvement of the present invention, at least one part of the middle portion of the industrial kiln runs horizontally.

In a further improvement of the present invention, an arch distance of the middle portion of the industrial kiln ranges from 1 time to 2 times an inner diameter of the internal chamber of the kiln body.

In a further improvement of the present invention, the transporting mechanism is in a form of a conveyor belt or a conveyor roller.

In a further improvement of the present invention, the transporting mechanism is in a form of a conveyor roller. Transporting is completed by several conveyor rollers rotating in a same direction. The conveyor rollers support a push plate for placing the member to be fired. The member to be fired or a carrier loading the member to be fired is placed on the push plate, and the conveyor rollers rotating in the same direction feed the push plate and the member to be fired placed on the push plate into the internal chamber of the kiln body for sintering.

In a further improvement of the present invention, the push plate employs a rectangular structure on the whole, and has an upper surface, a lower surface, and front, rear, left, and rear side surfaces. The lower surface of the push plate comes into contact with the conveyor rollers, and a recessed placing region is provided at a middle position of the upper surface to place the member to be fired or the carrier loading the member to be fired.

In a further improvement of the present invention, in at least a portion of the transporting mechanism that passes through the chamber of the kiln body, guardrails are disposed on two sides of the transporting mechanism. The left and right side surfaces of the push plate are recessed to form front-rear-through push plate grooves. Continuous protruding structures are disposed at corresponding positions of the guardrails on the two sides of the transporting mechanism to form guardrail protrusions. When the push plate advances on the conveyor rollers, the guardrail protrusions snap in the push plate grooves to avoid arch-up of the push plate.

In a further improvement of the present invention, in at least a portion of the transporting mechanism that passes through the chamber of the kiln body, guardrails are disposed on two sides of the transporting mechanism. Protruding structures are disposed on the left and right sides of the push plate to form push plate protrusions. Through grooves are disposed at positions of the guardrails that come into contact with the push plate protrusions to form guardrail grooves. When the push plate advances on the conveyor rollers, the push plate protrusions snap in the guardrail grooves.

In a further improvement of the present invention, in the front and rear side surfaces of the push plate, one has a protrusion and the other one has a left-right-through groove. When a plurality of push plates are on the conveyor rollers, corresponding protrusions and grooves of two push plates coming into contact in a front-rear direction can be engaged with each other.

In a further improvement of the present invention, a heat preservation layer is disposed outside an upright wall of the kiln body, and a thickness of the heat preservation layer is 8 cm to 12 cm.

Beneficial effect of the invention: compared with a conventional industrial kiln, in particular, a tunnel kiln, the present invention enables collection of excessive heat in a pre-heating portion and a cooling portion to transfer the same to a high-temperature firing portion, thus reducing a firing time and burning fuels of a high-temperature firing region, lowering a production cost, and protecting the environment by preventing exhaustion of a large amount of hot air. In the present invention, a push plate and an upright wall of a kiln body are connected in a snapping-like manner, such that it is ensured that no lift-up phenomenon occurs in an ascending process of a plurality of push plates, to facilitate transporting.

### BRIEF DESCRIPTION OF THE DRAWINGS

FIG. 1 is a schematic structural transverse sectional view of Embodiment 1 of the present invention.

FIG. 2 is a schematic structural transverse sectional view of Embodiment 2 of the present invention.

FIG. 3 is a schematic structural transverse sectional view of Embodiment 3 of the present invention.

FIG. 4 is a schematic structural cross-sectional view of a kiln body of the present invention.

FIG. 5 is a schematic structural diagram of a push plate of the present invention.

FIG. 6 is a schematic diagram of connection between a push plate and an upright wall of the present invention.

FIG. 7 is a schematic structural diagram of a variation of FIG. 4.

FIG. 8 is a schematic structural diagram of push plates connected in a front-rear direction of the present invention.

In the figures, 1—kiln body, 2—transporting mechanism, 3—arch structure, 4—rising portion, 5—middle portion, 6—descending portion, 7—guardrail, 701—guardrail protrusion, 702—guardrail groove, 8—push plate, 801—push plate groove, 802—push plate protrusion, 803—placing region, 9—heat preservation layer.

### DESCRIPTION OF THE EMBODIMENTS

To deepen understanding of the present invention, the present invention will be further described in detail below with reference to the accompanying drawings and embodiments. The embodiments are used only to explain the present invention and are not intended to limit the protection scope of the present invention.

### Embodiment 1

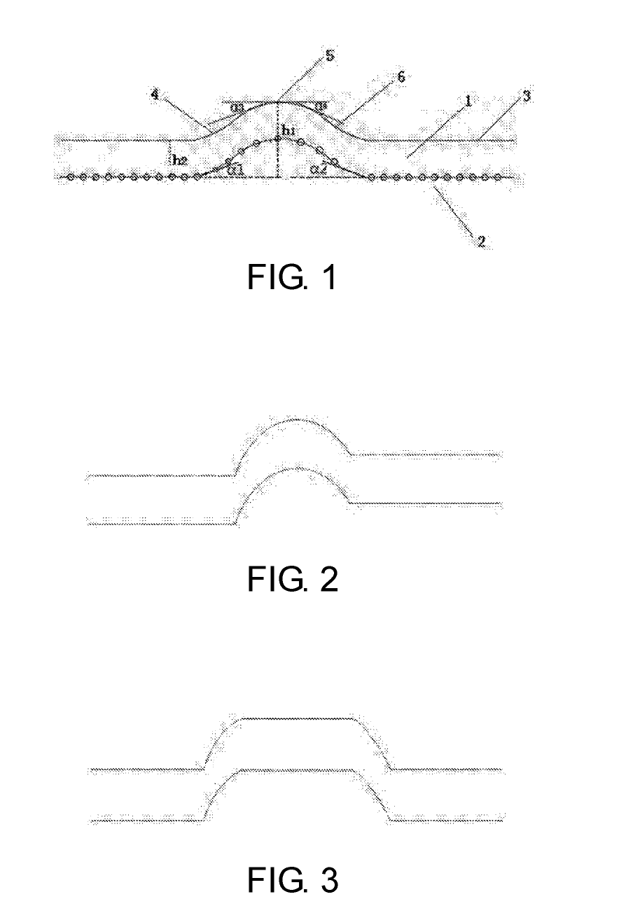

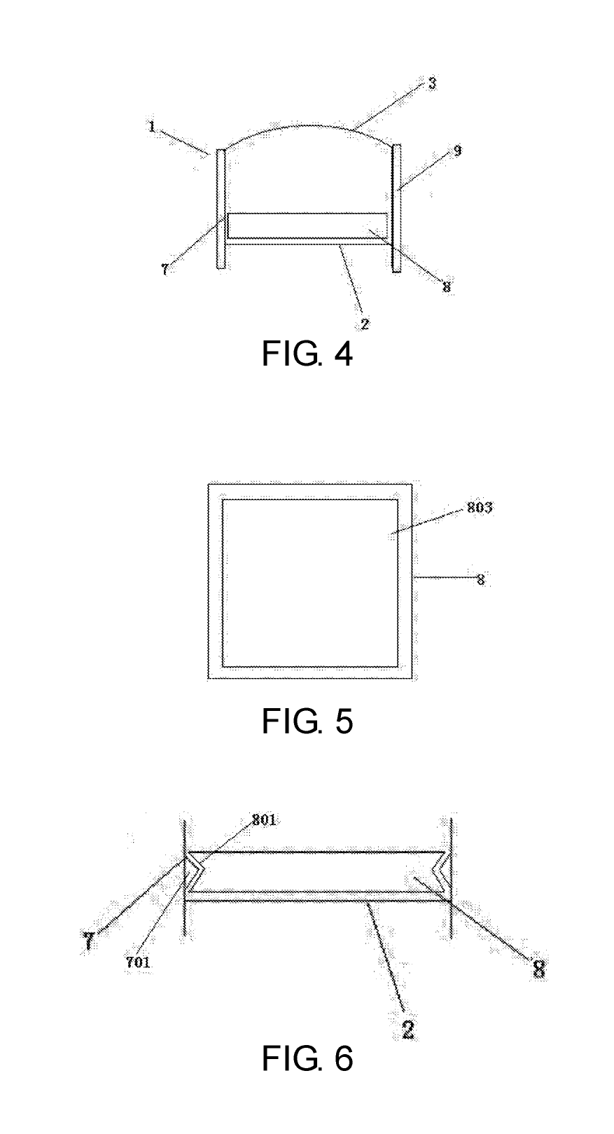

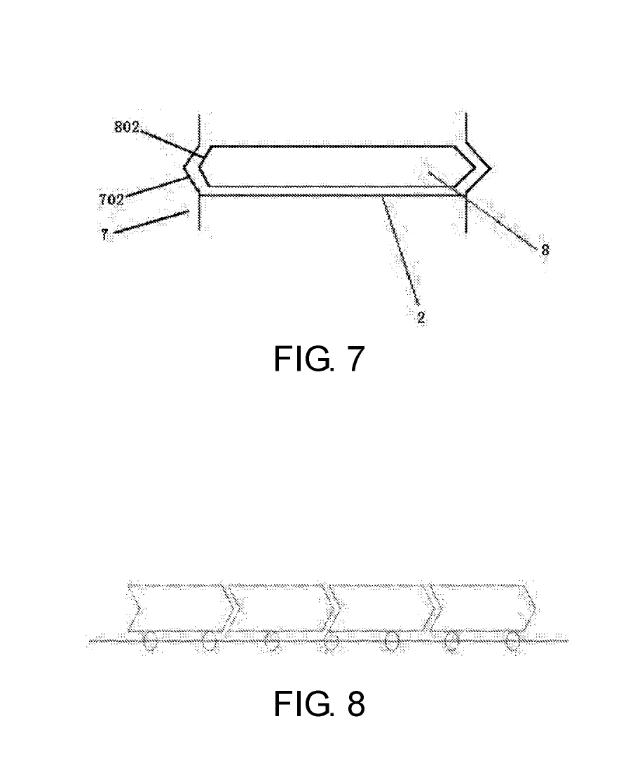

FIG. 1 shows an industrial kiln, employing a tunnel kiln design, and including a kiln body 1 and a transporting mechanism 2 that is configured to convey a member to be fired to pass through an internal chamber of the kiln body 1. The kiln body 1 is of a structure with an arched middle portion 3, and includes a rising portion 4, a middle portion 5, and a descending portion 6. A front end of the rising portion 4 is connected to a front horizontal portion, and a rear end of the descending portion 6 is connected to a rear horizontal portion. The transporting mechanism 2 passes through the internal chamber of the kiln body 1 in a parallel manner, and therefore the transporting mechanism 2 is also correspondingly divided into a front horizontal portion, a rising portion, a middle portion, a descending portion, and a rear horizontal portion. In the transporting mechanism 2, the front horizontal portion and the rising portion, the rising portion and the middle portion, the middle portion and the descending portion, and the descending portion and the rear horizontal portion are connected by means of curved surfaces with smooth transitions, respectively. The middle portion 5 is a portion with a highest temperature in the kiln body 1, and a high-temperature firing region is formed in the middle portion. At least one part of the front horizontal portion and at least one part of the rising portion 4 form a pre-heating region with a gradually increasing temperature, and at least one part of the descending portion 6 and at least one part of the rear horizontal portion form a cooling region with a gradually decreasing temperature. The transporting mechanism 2 conveys the member to be fired to sequentially pass through the front horizontal portion, the rising portion 4, the middle portion 5, the descending portion 6, and the rear horizontal portion. At least one part of the middle portion 5 of the industrial kiln runs horizontally. An arch distance of the middle portion of the industrial kiln ranges from 1 time to 2 times an inner diameter of the internal chamber of the kiln body 1. The transporting mechanism 2 is in form of a conveyor belt or a conveyor roller. In this embodiment, the transporting mechanism 2 is in a form of a conveyor roller (as shown in FIG. 4 and FIG. 8). Transporting is completed by several conveyor rollers rotating in a same direction. The conveyor rollers support a push plate 8 for placing the member to be fired. The member to be fired or a carrier loading the member to be fired is placed on the push plate 8, and the conveyor rollers rotating in the same direction feed the push plate 8 and the member to be fired placed on the push plate 8 into the internal chamber of the kiln body 1 for sintering. The push plate 8 employs a rectangular structure on the whole, and has an upper surface, a lower surface, and front, rear, left, and rear side surfaces. The lower surface of the push plate 8 comes into contact with the conveyor rollers, and a recessed placing region 803 is provided at a middle position of the upper surface to place the member to be fired or the carrier loading the member to be fired (as shown in FIG. 5). In at least a portion of the transporting mechanism 2 that passes through the chamber of the kiln body 1, guardrails 7 are disposed on two sides of the transporting mechanism 2. The left and right side surfaces of the push plate 8 are recessed to form front-rear-through push plate grooves 801. Continuous protruding structures are disposed at corresponding positions of the guardrails 7 on the two sides of the transporting mechanism 2 to form guardrail protrusions 701. When the push plate 8 advances on the conveyor rollers, the guardrail protrusions 701 snap in the push plate grooves 801 to avoid arch-up of the push plate 8 (as shown in FIG. 6). A variation may also be made. In at least a portion of the transporting mechanism 2 that passes through the chamber of the kiln body 1, guardrails 7 are disposed on two sides of the transporting mechanism 2. Protruding structures are disposed on the left and right sides of the push plate 8 to form push plate protrusions 802. Through grooves are disposed at positions of the guardrails 7 that come into contact with the push plate protrusions 802 to form guardrail grooves 702. When the push plate 8 advances on the conveyor rollers, the push plate protrusions 802 snap in the guardrail grooves 702 (as shown in FIG. 7). In the front and rear side surfaces of the push plate 8, one has a protrusion and the other one has a left-right-through groove. When a plurality of push plates 8 are on the conveyor rollers, corresponding protrusions and grooves of two push plates 8 coming into contact in a front-rear direction can be engaged with each other (as shown in FIG. 8). In this embodiment, a heat preservation layer 9 is disposed outside an upright wall of the kiln body 1, and a thickness of the heat preservation layer 9 is 8 cm to 12 cm (as shown in FIG. 4). An angle between the rising portion of the transporting mechanism and a horizontal line is α1, and an angle between the descending portion of the transporting mechanism and the horizontal line is α2, where α1 is equal to α2. Angles between a tangent line at a highest point of a middle portion of an upper portion and tangent lines of curved surfaces of the rising portion and the descending portion are α3 and α4, where α3 is equal to α4. A vertical distance between the highest point of the middle portion of the upper portion and the horizontal portion of the transporting mechanism is h1, and a vertical distance between the upper portion and the transporting mechanism is h2, where a ratio of h1 to h2 ranges from 2:1 to 3:1.

### Embodiment 2

FIG. 2 shows an industrial kiln, employing a tunnel kiln design, and including a kiln body and a transporting mechanism that is configured to convey a member to be fired to pass through an internal chamber of the kiln body, where the kiln body is of a structure with an arched middle portion, and includes a rising portion, a middle portion, and a descending portion. A front end of the rising portion is connected to a front horizontal portion, and a rear end of the descending portion is connected to a rear horizontal portion. The transporting mechanism passes through the internal chamber of the kiln body in a parallel manner, and therefore the transporting mechanism is also correspondingly divided into a front horizontal portion, a rising portion, a middle portion, a descending portion, and a rear horizontal portion, where in the transporting mechanism, the front horizontal portion and the rising portion, the rising portion and the middle portion, the middle portion and the descending portion, and the descending portion and the rear horizontal portion are connected by means of curved surfaces with smooth transitions, respectively. The middle portion is a portion with a highest temperature in the kiln body, and a high-temperature firing region is formed in the middle portion. At least one part of the front horizontal portion and at least one part of the rising portion form a pre-heating region with a gradually increasing temperature, and at least one part of the descending portion and at least one part of the rear horizontal portion form a cooling region with a gradually decreasing temperature. The transporting mechanism conveys the member to be fired to sequentially pass through the front horizontal portion, the rising portion, the middle portion, the descending portion, and the rear horizontal portion. In this embodiment, the front horizontal portion and the rear horizontal portion of the kiln body are not on a same horizontal line. Similarly, the front horizontal portion and the rear horizontal portion of the transporting mechanism are not on a same horizontal line, either. This design makes the pre-heating region and the cooling region of the kiln have different horizontal heights. Correspondingly, amounts of heat transferred to the central high-temperature firing region are not the same, there is a temperature difference, and the temperature of the cooling portion is transferred to the high-temperature firing region to the greatest extent. Other parts are the same as those of Embodiment 1.

### Embodiment 3

FIG. 3 shows an industrial kiln, employing a tunnel kiln design, and including a kiln body and a transporting mechanism that is configured to convey a member to be fired to pass through an internal chamber of the kiln body, where the kiln body is of a structure with an arched middle portion, and includes a rising portion, a middle portion, and a descending portion. A front end of the rising portion is connected to a front horizontal portion, and a rear end of the descending portion is connected to a rear horizontal portion. The transporting mechanism passes through the internal chamber of the kiln body in a parallel manner, and therefore the transporting mechanism is also correspondingly divided into a front horizontal portion, a rising portion, a middle portion, a descending portion, and a rear horizontal portion, where in the transporting mechanism, the front horizontal portion and the rising portion, the rising portion and the middle portion, the middle portion and the descending portion, and the descending portion and the rear horizontal portion are connected by means of curved surfaces with smooth transitions, respectively. The middle portion is a portion with a highest temperature in the kiln body, and a high-temperature firing region is formed in the middle portion. At least one part of the front horizontal portion and at least one part of the rising portion form a pre-heating region with a gradually increasing temperature, and at least one part of the descending portion and at least one part of the rear horizontal portion form a cooling region with a gradually decreasing temperature. The transporting mechanism conveys the member to be fired to sequentially pass through the front horizontal portion, the rising portion, the middle portion, the descending portion, and the rear horizontal portion. In this embodiment, a horizontal distance of the high-temperature firing region in the middle portion is relatively long, so that a high-temperature sintering time is prolonged, and sintering of the member to be fired is more sufficient, thereby improving the sintering effect. Other parts are the same as those of Embodiment 1.

The basic principles, main features and advantages of the present invention have been shown and described above. It should be understood by those skilled in the art that the present invention is not limited by the foregoing embodiments, the foregoing embodiments and description are only used to describe the principles of the present invention, and various modifications and improvements of the present invention can be further made without departing from the spirit and scope of the present invention, and these modifications and improvements all fall within the scope of the present invention. The protection scope of the present invention is defined by the appended claims and their equivalents.

1. An industrial kiln, employing a tunnel kiln design, and comprising a kiln body and a transporting mechanism that is configured to convey a member to be fired to pass through an internal chamber of the kiln body, wherein the kiln body is of a structure with an arched middle portion, and comprises a rising portion, a middle portion, and a descending portion; a front end of the rising portion is connected to a front horizontal portion, and a rear end of the descending portion is connected to a rear horizontal portion; the transporting mechanism passes through the internal chamber of the kiln body in a parallel manner, and therefore the transporting mechanism is also correspondingly divided into a front horizontal portion, a rising portion, a middle portion, a descending portion, and a rear horizontal portion, wherein in the transporting mechanism, the front horizontal portion and the rising portion, the rising portion and the middle portion, the middle portion and the descending portion, and the descending portion and the rear horizontal portion are connected by means of curved surfaces with smooth transitions, respectively; the middle portion is a portion with a highest temperature in the kiln body, and a high-temperature firing region is formed in the middle portion; at least one part of the front horizontal portion and at least one part of the rising portion form a pre-heating region with a gradually increasing temperature, and at least one part of the descending portion and at least one part of the rear horizontal portion form a cooling region with a gradually decreasing temperature; and the transporting mechanism conveys the member to be fired to sequentially pass through the front horizontal portion, the rising portion, the middle portion, the descending portion, and the rear horizontal portion.

2. The industrial kiln according to claim 1, wherein at least one part of the middle portion of the industrial kiln runs horizontally.

3. The industrial kiln according to claim 1, wherein an arch distance of the middle portion of the industrial kiln ranges from 1 time to 2 times an inner diameter of the internal chamber of the kiln body.

4. The industrial kiln according to claim 1, wherein the transporting mechanism is in a form of a conveyor belt or a conveyor roller.

5. The industrial kiln according to claim 4, wherein the transporting mechanism is in a form of a conveyor roller; transporting is completed by several conveyor rollers rotating in a same direction; the conveyor rollers support a push plate for placing the member to be fired; the member to be fired or a carrier loading the member to be fired is placed on the push plate, and the conveyor rollers rotating in the same direction feed the push plate and the member to be fired placed on the push plate into the internal chamber of the kiln body for sintering.

6. The industrial kiln according to claim 5, wherein the push plate employs a rectangular structure on the whole, and has an upper surface, a lower surface, and front, rear, left, and rear side surfaces; the lower surface of the push plate comes into contact with the conveyor rollers, and a recessed placing region is provided at a middle position of the upper surface to place the member to be fired or the carrier loading the member to be fired.

7. The industrial kiln according to claim 6, wherein in at least a portion of the transporting mechanism that passes through the internal chamber of the kiln body, guardrails are disposed on two sides of the transporting mechanism; the left and right side surfaces of the push plate are recessed to form front-rear-through push plate grooves; continuous protruding structures are disposed at corresponding positions of the guardrails on the two sides of the transporting mechanism; and when the push plate advances on the conveyor rollers, the protruding structures snap in the push plate grooves to avoid arch-up of the push plate.

8. The industrial kiln according to claim 6, wherein in at least a portion of the transporting mechanism that passes through the internal chamber of the kiln body, guardrails are disposed on two sides of the transporting mechanism; protruding structures are disposed on the left and right sides of the push plate to form push plate protrusions; through grooves are disposed at positions of the guardrails that come into contact with the push plate protrusions; and when the push plate advances on the conveyor rollers, the push plate protrusions snap in the through grooves.

9. The industrial kiln according to claim 6, wherein in the front and rear side surfaces of the push plate, one has a protrusion and the other one has a left-right-through groove; and when a plurality of push plates are on the conveyor rollers, corresponding protrusions and grooves of two push plates coming into contact in a front-rear direction can be engaged with each other.

10. The industrial kiln according to claim 1, wherein a heat preservation layer is disposed outside an upright wall of the kiln body, and a thickness of the heat preservation layer is 8 cm to 12 cm.

11. The industrial kiln according to claim 2, wherein an arch distance of the middle portion of the industrial kiln ranges from 1 time to 2 times an inner diameter of the internal chamber of the kiln body.

12. The industrial kiln according to claim 2, wherein the transporting mechanism is in a form of a conveyor belt or a conveyor roller.

13. The industrial kiln according to claim 2, wherein a heat preservation layer is disposed outside an upright wall of the kiln body, and a thickness of the heat preservation layer is 8 cm to 12 cm.
